(19) United States
(12) Patent Application Publication
(10) Pub. No.: US 2023/0157333 A1
(43) Pub. Date: May 25, 2023

(54) MUSSEL BEAN PASTE AND PREPARATION METHOD THEREOF

(71) Applicant: ZHEJIANG GONGSHANG UNIVERSITY, HANGZHOU (CN)

(72) Inventors: ZHIYUAN DAI, HANGZHOU (CN); LIPING GUO, HANGZHOU (CN); WEN YAN, HANGZHOU (CN); FENGXIAN ZHU, HANGZHOU (CN); JIANLONG ZHU, HANGZHOU (CN)

(21) Appl. No.: 17/850,917

(22) Filed: Jun. 27, 2022

(30) Foreign Application Priority Data
Nov. 23, 2021 (CN) 202111402348X

(51) Int. Cl. A23L 17/50; A23L 11/00; A23L 5/20; A23L 13/40

(52) U.S. Cl. CPC A23L 17/50; A23L 11/07; A23L 5/25; A23L 13/46; A23L 31/00

(57) ABSTRACT

A mussel soybean paste and a preparation method thereof are provided, the preparation method includes: sterilizing soaked soybeans, adding mussel cooking liquor hydrolysate, and then inoculating Aspergillus oryzae for making koji to obtain soybean koji; sterilizing soaked rice, and inoculating Aspergillus oryzae for making koji to obtain rice koji; mixing the rice koji with the soybean koji to obtain a koji material; adding the koji material and salt into mussel meat for anaerobic fermentation, grinding an obtained mussel soybean paste semi-finished product by using a colloid mill, and conducting sterilizing to obtain the mussel soybean paste. The mussel soybean paste which is natural, nutritional and good in flavor can be prepared, and the added value of mussels is increased.

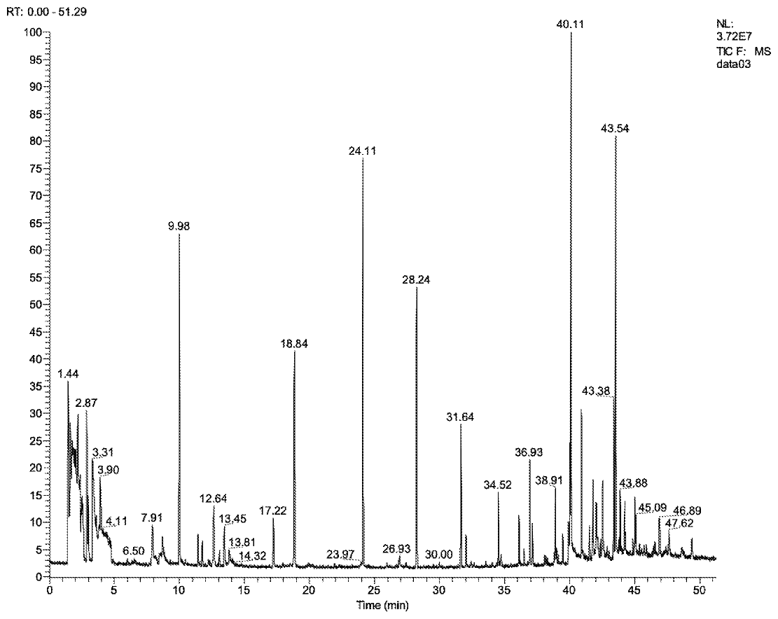

### TECHNICAL FIELD

The disclosure belongs to the field of marine food seasoning technologies, relates to a mussel bean paste and a preparation method thereof, in particular, to a preparation process for making mussel bean paste by fermentation of mixed mussel meat with koji essence in soy sauce.

### DESCRIPTION OF RELATED ART

Mussels are commonly known as “sea rainbow” and “light vegetable”, and are known as “sea eggs”, which is one of China's important economic marine shellfish. The mussels have high nutritional value, include a protein content of 59% and a fat content of 7%, and contain 8 kinds of essential amino acids such as taurine; most of the fat are unsaturated fatty acids. The mussels have a certain medicinal value, with liver and kidney, blood, cure deficiency fatigue, night sweats, impotence, lumbago, and other effects. Coastal residents often eat the mussels, as the transportation and fresh-keeping costs of living mussels are high, the consumption of inland residents is relatively small. Except for fresh mussels with shells, the mussels in China are mainly processed by quick freezing and drying. The product form is single and the value-added range is small. Due to the concentration of harvest season and other reasons, the mussels are less processed and utilized, and a large number of finished mussels cannot be fully consumed, which is not conducive to the development of mussel industry. In addition, in the process of mussel processing, it is necessary to add water to cook the mussels and collect meat. In the process, a large amount of soup (hereinafter referred to as mussel cooking liquid) will be produced. For every ton of mussels produced, 1.5 tons of mussel cooking liquid will be produced, most mussel cooking liquid is directly discharged into the sea without treatment, which not only wastes resources, but also pollutes the marine environment. The Mussel cooking liquid is not only rich in protein, sugar, vitamins, trace elements, but also contains taurine, free amino acids, and other biologically active substances.

Sauce is a condiment “pronoun”, the unique aroma formed by the volatilization of flavor substances produced by microbial fermentation of raw materials of the sauce has a mixed flavor of salty, fresh, sour, sweet and bitter. The sauce contains a variety of minerals, vitamins, linoleic acid, phospholipids, dietary fiber and other nutrients, which help to resist fatigue, oxidation, thrombosis, etc. Mussel bean paste, a natural seasoning made by fermentation of edible fungus and mussel meat, is rich in nutrition and flavor, which improves the utilization level of mussel resources and has broad market prospects and development value.

Chinese patent application No. CN201610057971.9 (corresponding to Chinese patent publication No. CN105707843A) discloses a method of producing mussel paste by compound biological enzymatic hydrolysis, in which raw material is cleaned, steamed, crushed and hydrolyzed by adding protease and cellulase, and the enzymatic hydrolysis is terminated by heating to a certain extent, and salt and ginger juice are added to the enzymatic hydrolysis solution for seasoning, and cinnamon oil or clove oil is added to the enzymatic hydrolysis solution for flavoring. The shortcoming of the above method is: using the protease to hydrolyze mussel meat to produce products with high cost and poor flavor.

Chinese patent application No. CN201410049994.6 (corresponding to Chinese patent publication No. CN103815383A) discloses a mussel soy sauce and production method, which process is to cook and concentrate mussel soup, and then add a mixed strains of bacteria (including Aspergillus oryzae, Aspergillus sojae, etc.), fermentation to obtain fermentation liquid, using defatted soybean meal, bran, rice hulls, rice flour to add another mixed strains of bacteria to make koji. Adding the fermentation liquid and salt to a koji powder obtained from making koji for fermentation, finally the soy sauce is prepared. The shortcoming of this method is that the mussel meat is not fully utilized.

### SUMMARY OF THE DISCLOSURE

The technical problem to be solved by the disclosure is to provide a method for preparing natural and nutritious mussel bean paste with good flavor, thereby increasing added value of mussels.

To solve the above problem, the disclosure provides a method for preparing mussel bean paste, including the following steps:

1) Making Koji:

S1, sterilizing soaked soybeans (110˜121° C. sterilization 10˜30 min), first adding mussel cooking liquor hydrolysate (adding the mussel cooking liquor hydrolysate when cooling to be less than 40° C.), and then inoculating Aspergillus oryzae (i.e., Aspergillus oryzae spores) with an inoculum amount of 0.1% (i.e., the Aspergillus oryzae: the soaked soybean=0.1% by weight ratio) to obtain a first koji material, placing the first koji material in a constant temperature and humidity incubator with a first temperature of 28° C. to 32° C. and a first relative humidity of (85±2) % for static culture to make koji for 2 days to 4 days to obtain soybean koji; the mussel cooking liquor hydrolysate: the soaked soybeans=4% to 10% by weight ratio (i.e., an added amount of the mussel cooking liquor hydrolysate is 4% to 10% of a wet weight of soybeans);

the mussel cooking liquor hydrolysate is obtained by concentrating mussel cooking liquor and then performing enzymic hydrolysis with flavor protease;

S2, sterilizing soaked rice (110˜121° C. sterilization 10˜30 min), inoculating Aspergillus oryzae (inoculating the Aspergillus oryzae spores when cooling to be less than 38° C.) with an inoculum amount of 0.1% (i.e., the Aspergillus oryzae: the soaked rice=0.1% by weight ratio) to obtain a second koji material, placing the second koji material in a constant temperature and humidity incubator with a second temperature of 28° C. to 32° C. and a second relative humidity of (85±2%) for static culture to make koji for 2 days to 4 days to obtain rice koji;

S3: mixing the rice koji with the soybean koji to obtain a koji material; the rice koji: the soybean koji=1:0.5 to 2 by weight ratio;

2) Fermentation:

adding the koji material and salt into mussel meat to form a fermentation system, sealing after mixing evenly, and obtaining a mussel bean paste semi-finished product through anaerobic fermentation at 37° C. to 42° C. for 21 days to 30 days;

the mussel meat: the koji material=1:0.5 to 2 by weight ratio;

in the fermentation system, a quality of the salt accounts for 10˜16% of the fermentation system;

3) Grinding Paste and Sterilizing:

grinding the mussel soybean paste semi-finished product by using a colloid mill, and sterilizing (85±5° C. sterilization 20±5 min) to obtain the mussel soybean paste.

In an embodiment, in the S1: opening an incubator door every 6 hours to ventilate (5±0.5) min, turning the first koji material for a first time when first surface mycelium makes the first koji material caking (about the 6th to 9th hour after the culture), and turning the first koji material again when a temperature of the first koji material rises above 35° C.;

in the S2: opening an incubator door every 6 hours to ventilate (5±0.5) min, turning second koji material for a first time when second surface mycelium makes the second koji material coking (about the 12th to 16th hour after the culture), and turning the second koji material again when a temperature of the second koji material rises above 35° C.

In an embodiment, in the S1, the first temperature is 31° C., and the first relative humidity is 85%; in the S2, the second temperature is 31° C., and the second relative humidity is 85%.

In an embodiment, a method for preparing the mussel cooking liquor hydrolysate includes:

concentrating the mussel cooking liquor to 15-20% of an original volume of the mussel cooking liquor to obtain a concentrated liquid; and

adding the flavor protease with a weight of 0.3% of by mass of a weight of the concentrated liquid into the concentrated liquid, and performing the enzymatic hydrolysis at 35° C. to 50° C. for 1 h to 3 h, and obtaining the mussel cooking liquor hydrolysate after enzyme inactivation (i.e., after the enzymatic hydrolysis, the enzyme was killed in boiling water bath for 10 min).

In an embodiment, in the step 2), the mussel meat: the koji material=1:1 by weight ratio.

The disclosure further provides a mussel bean paste prepared by using any of the above methods.

The mussel bean paste produced by the disclosure is fresh and mellow, suitable salty and sweet, with a strong seafood aroma and a coordinated odor, moderately viscous and fine and uniform, with the following parameters in the product:

amino acid nitrogen ≥0.50 g/100 g;

total acid (in terms of lactic acid)≤2.00 g/100 g;

water content ≤60% (mass fraction).

Microbiological indicators in the product are as follows:

\textcircled{1} coliform/(MPN/100 g)≤30; \textcircled{2} pathogenic bacteria (salmonella, Staphylococcus aureus, shigella): not detected.

From the above data, it can be seen that the product, i.e., the mussel bean paste produced by the disclosure meets the quality requirements of the national standard GB2718-2014 “National Standard for Food Safety Brewing Sauce”.

The disclosure uses mussels, soybeans and rice as raw materials and uses the specific method to prepare and obtain the mussel bean paste, which broadens the scope of use/processing of mussels and has the advantages of simple process and short production period.

The disclosure has the following technical advantages compared with the prior art:

(1) the mussel meat as the main raw material, adding soybeans, rice as auxiliary ingredients, lower cost, rich in nutrition, adding the mussel cooking liquor hydrolysate makes the production cycle of the making koji shorter, the overall process is simpler, not only enrich the type of sauce, but also realize the mussel high value utilization;

(2) the mussel bean paste not only has uniform texture and bright color, but also has rich seafood flavor, fresh, sweet and mellow taste. At the same time, it is rich in small molecular peptides, free amino acids, taurine, linoleic acid and other nutrients. It is easy to digest and absorb, and helps to resist oxidation and reduce blood lipids, blood pressure and blood glucose; and

(3) in terms of flavor, fermented mussels and soybeans produce polypeptides, free amino acids and fatty acids, and rice koji is hydrolyzed to obtain reducing sugars, which is conducive to the biochemical reactions such as Maillard aroma generation reaction to form flavor, and accelerates the formation of alcohols, aldehydes, esters and other flavor substances, so that mussel bean paste has the characteristic aroma of mussels and soybean rice fermentation, with harmonious and rich odor, mellow and soft taste.

### BRIEF DESCRIPTION OF THE DRAWING

Specific embodiments of the disclosure are described in further detail below in conjunction with the accompanying figure.

The figure illustrates a gas chromatography-mass spectrometry (GC_MS) spectrum of volatile flavor substances of mussel bean paste.

### DETAILED DESCRIPTION OF EMBODIMENTS

The disclosure is further described below in connection with specific embodiments, but the scope of protection of the disclosure is not limited to.

In the disclosure:

Enzyme activity of flavor protease enzyme is 30 u/mg, for example, flavor protease enzyme with CAS No. 9001-92-1 produced by Beijing Kangrena Biotechnology Co., Ltd. can be selected.

A content of Aspergillus oryzae spores ≤3 billion/g, for example, Aspergillus oryzae spores with a model of Chunfeng local wine CICC2339 (Shanghai wine 3.042) produced by Yiyuan Kangyuan Biotechnology Co., Ltd. can be selected.

Embodiment 1, a method for preparing mussel bean paste, including the following steps in sequence:

1) Making Koji:

\textcircled{1} Making Soybean Koji:

soaking soybeans for 4 h to 5 h to absorb water and expand (throughout the soaking process, to ensure that the soybeans are always submerged in water), to obtain soaked soybeans;

after sterilizing the soaked soybeans by high temperature (110° C. to 121° C., 0.1 MPa pressure) for 30 min, when cooling to 40° C., adding mussel cooking liquor hydrolysate with a weight of 4% of a wet weight of the soybeans (i.e., the mussel cooking liquor hydrolysate: the soaked soybeans=4% by weight ratio), and inoculating Aspergillus oryzae spores with an inoculum amount of 0.1%, i.e., the Aspergillus oryzae spores: the soaked soybeans=0.1% by weight ratio; mixing evenly and placing in a constant temperature and humidity incubator with 31° C. and relative humidity of 85% for static aerobic culture, opening an incubator door every 6 hours to ventilate 5 min, when surface mycelium makes koji material caking, turning the koji material for a first time (about 6 to 9 hours after the culture), and later, when a temperature of the koji material rises above 35° C., turning the koji material again, making koji for 2 days, to obtain the soybean koji;

a method for preparing the mussel cooking liquor hydrolysate, includes:

cooking 3 kg of mussel with 1 L of water in a conventional way to obtain mussel cooking liquor, concentrating the mussel cooking liquor to 160 mL in a conventional way to obtain concentrated mussel cooking liquor;

adding flavor protease with a weight of 0.3% of a weight of the concentrated mussel cooking liquor into the concentrated mussel cooking liquor, performing enzymatic hydrolysis at 35° C. to 50° C. for 3 h, after enzyme inactivation, obtaining the mussel cooking liquor hydrolysate.

\textcircled{2} Making Rice Koji:

soaking rice in water until there is no white hard core (generally need to soak at least about 12 hours, the entire soaking process, to ensure that the rice is always submerged in water), sterilizing soaked rice by high temperature (110 to 121° C., 0.1 MPa pressure) for 30 min, inoculating Aspergillus oryzae spores with an inoculum amount of 0.1% when cooling to 38° C., that is, the Aspergillus oryzae spores: the soaked rice=0.1% by weight ratio, placing in a constant temperature and humidity incubator with 31° C. and relative humidity of 85% for static aerobic culture, opening an incubator door every 6 hours to ventilate 5 min, turning koji material for a first time when surface mycelium makes the koji material coking (about the 12th to 16 hours after the culture), and turning the koji material again when a temperature of the koji material rises above 35° C., making koji for 4 days to obtain the rice koji;

\textcircled{3} compounding the rice koji with the soybean koji in accordance with a weight ratio of 3:2 to obtain a koji material (i.e., compound koji material).

2) fermentation: mixing the compound koji material obtained by the step 1) with fresh mussel meat in accordance with a weight ratio of 1:1 evenly, and adding a mass fraction of 13% of salt, that is, the salt: (the salt+the mussel meat+the compound koji material)=13% by weight ratio, mixing evenly and static heat preservation anaerobic fermentation at a temperature of 40° C. for 24 days, a mussel bean paste semi-finished product is obtained;

3) Grinding Paste and Sterilizing:

grinding the mussel bean paste semi-finished product obtained by the step 2) by using a colloid mill (finely crushed to 40˜80 mesh), and heat preservation at 85° C. for 20 min to sterilize, the mussel bean paste is obtained.

Flavor Substance Detection Results:

Using GC_MS to determine the volatile flavor substances of the mussel bean paste. GC conditions: an injection port temperature is 250° C.; an injection method: no diversion; carrier gas: helium (purity 99.99%); a flow rate is 1.0 mL/min; chromatographic column: DP-5MS quartz capillary chromatographic column (30 m×0.25 mm, 0.25 μm); program temperature rise conditions: keeping 40° C. for 2 min, rising to 92° C. at 4° C./min and keeping 2 min, rising to 200° C. at 5° C./min and keeping 0 min; rising to 240° C. at 6° C./min and keeping 6 min; mass spectrometry conditions: electron bombardment ion source, an ionization voltage is 70 eV, a transmission line temperature is 250° C., an ion source temperature is 250° C., a mass scan range is in a range of 33 u to 450 u.

Fifty-five volatile substances were detected from the mussel bean paste obtained in the Embodiment 1, including aromatic compounds, alcohols, esters, aldehydes, phenols, nitrogenous compounds, and sulfur-containing compounds. The details are illustrated in the figure.

Antioxidant Effect Test:

sample pretreatment: weighing 5.0 g of the mussel bean paste, adding 100 mL of 60% ethanol solution to homogenize and then extract for 30 min, centrifuging at 3000 r/min for 20 min and then supernatant was fixed to 100 ml to obtain 50 mg/mL of sample extract liquid and diluting to 10, 20, 30 and 40 mg/mL concentrations with 60% ethanol solution.

Determination of total antioxidant capacity of fluorescence recovery after photobleaching (FRAP):

\textcircled{1} A standard curve was plotted by replacing the sample with a standard solution of 0.5-3.5 mmol/L FeSO₄. The molar concentration (X) was regressed on the absorbance (Y), and ferrous sulfate was used as the standard for the standard curve plotting. The linearity of ferrous sulfate was good within 0.5 mmol to 3.5 mmol, and the regression equation was: Y=0.3826X-0.0011, R2=0.99; \textcircled{2} the extracts of each group of sauces were measured, and the amount of iron ion reduction was calculated with reference to the standard curve of ferrous sulfate, and the total antioxidant capacity was expressed in terms of iron ion reduction. The measured total antioxidant capacity of FRAP of 50 mg/mL mussel bean paste extract was 129.52 mmol FeSO₄/g.

Hydroxyl (—OH) radical scavenging rate determination:

A1: 0.4 mL ultrapure water+100 μL 9 millimole per liter (mmol/L, shorted as mM) salicylic acid-ethanol+400 μL sample liquid+100 μL 9 mM FeCL₂ solution+100 μL 8.8 mM H₂O₂ solution; A2: 0.5 mL ultrapure water+0.4 mL sample liquid+100 μL 9 mM FeCL₂ solution+100 μL 8.8 mM H₂O₂ solution; A3: 0.8 mL ultrapure water+100 μL 9 mM salicylic acid-ethanol+100 μL 9 mM FeCL₂ solution+100 μL 8.8 mM H₂O₂ solution; mixing the above reaction solution and reacting at 37° C. for 30 min, measuring the absorbance values A1, A2, A3 at 510 nm and recording. Hydroxyl radical (—OH) scavenging rate=(1−(A1−A2)/A3)*100%. The hydroxyl radical (—OH) scavenging rate of 50 mg/mL mussel bean paste extract was measured to be 74%.

For comparative embodiment 1-1, the use of the mussel cooking liquor hydrolysate in the making soybean koji in the step 1) of the embodiment 1 was eliminated; that is:

\textcircled{1} Making Soybean Koji:

sterilizing soaked soybeans by high temperature for 30 min, when cooling to 40° C., inoculating Aspergillus oryzae spores with an inoculum amount of 0.1%, i.e., the Aspergillus oryzae spores: the soaked soybeans=0.1% by weight ratio; mixing evenly and placing in a constant temperature and humidity incubator with 31° C. and relative humidity of 85% for static aerobic culture, opening an incubator door every 6 hours to ventilate 5 min, when surface mycelium makes koji material caking, turning the koji material for a first time, and later, when the temperature of the koji material rises above 35° C., turning the koji material again, making koji for 3 days, to obtain the soybean koji;

other steps are the same as those in the embodiment 1.

For a comparative embodiment 1-2, the making koji in the step 1) of the embodiment 1 was changed to: eliminate the use of mussel cooking liquor hydrolysate of making the soybean koji and replace it with the use of mussel cooking liquor hydrolysate in making the rice koji; that is,

\textcircled{1} Making Soybean Koji:

sterilizing soaked soybeans by high temperature for 30 min, when cooling to 40° C., inoculating Aspergillus oryzae spores with an inoculum amount of 0.1%, i.e., the Aspergillus oryzae spores: the soaked soybeans=0.1% by weight ratio; mixing evenly and placing in a constant temperature and humidity incubator with 31° C. and relative humidity of 85% for static aerobic culture, opening an incubator door every 6 hours to ventilate 5 min, when surface mycelium makes koji material caking, turning the koji material for a first time, and later, when the temperature of the koji material rises above 35° C., turning the koji material again, making koji for 3 days, to obtain the soybean koji.

\textcircled{2} Making Rice Koji:

sterilizing soaked rice by high temperature for 30 min, when cooling to 38° C., adding mussel cooking liquor hydrolysate with a weight of 4% of a wet weight of the rice (i.e., the mussel cooking liquor hydrolysate: the soaked rice=4% by weight ratio), then inoculating Aspergillus oryzae spores with an inoculum amount of 0.1%, that is, the Aspergillus oryzae spores: the soaked rice=0.1% by weight ratio, placing in a constant temperature and humidity incubator with 31° C. and relative humidity of 85% for static aerobic culture, opening an incubator door every 6 hours to ventilate 5 min, turning koji material for a first time when surface mycelium makes the koji material coking, and turning the koji material again when a temperature of the koji material rises above 35° C., making koji for 3 days to obtain the rice koji;

other steps are the same as those in the embodiment 1.

For a comparative embodiment 1-3, making koji of the step 1) in the embodiment 1 is changed to that: the mussel cooking liquor hydrolysate is used in making rice koji; that is, the mussel cooking liquor hydrolysate is used in both making soybean koji and making rice koji; the method of making rice koji is same as the comparative embodiment 1-2, and other steps are same as those in the embodiment 1.

For a comparative embodiment 1-4, “adding mussel cooking liquor hydrolysate with a weight of 4% of a wet weight of the soybeans” in the embodiment 1 is changed to “adding mussel cooking liquor hydrolysate with a weight of 10% of a wet weight of the soybeans”; and the other steps are same as those in the embodiment 1.

For a comparative embodiment 1-5, eliminating the use of mussel cooking liquor hydrolysate in making soybean koji in the step 1) of the embodiment 1; and the concentrated mussel cooking liquor was fermented separately; that is:

\textcircled{1} Making Soybean Koji:

sterilizing soaked soybeans by high temperature for 30 min, when cooling to 40° C., inoculating Aspergillus oryzae spores with an inoculum amount of 0.1%; mixing evenly and placing in a constant temperature and humidity incubator with 31° C. and relative humidity of 85% for static aerobic culture, opening an incubator door every 6 hours to ventilate 5 min, when surface mycelium makes koji material caking, turning the koji material for a first time (about 6 to 9 hours after the culture), and later, when a temperature of the koji material rises above 35° C., turning the koji material again, making koji for 3 days to obtain the soybean koji;

The others are the same as the step 1 of the embodiment 1; that is, other preparation processes of the compound koji material are the same as those in embodiment 1.

Another: mussel fermentation liquid is prepared by:

adding flavor protease with a weight of 0.3% of a weight of the concentrated mussel cooking liquor into the concentrated mussel cooking liquor and inoculating Aspergillus oryzae spores with an inoculum amount of 0.1%, (i.e., the Aspergillus oryzae spores accounts for the concentrated mussel cooking liquor is 0.1% by weight ratio), performing enzymatic hydrolysis at 35° C. to 50° C. for 3 h, and obtaining the mussel fermentation liquid.

In the Step 2):

mixing the compound koji material with mussel meat, the mussel fermentation liquid according to a weight ratio of 2:1:1 evenly, and then adding the salt with a mass fraction of 13%, mixing evenly, static heat preservation anaerobic fermentation at 40° C. for 24 days, to obtain a mussel bean paste semi-finished product.

The rest of the subsequent process is same as those in embodiment 1.

For a comparative embodiment 2-1, the step 2) of the embodiment 1 is changed to that:

mixing the compound koji material with mussel meat in accordance with a weight ratio of 1:2, and adding a mass fraction of 15% of salt; the other steps are same as those in the embodiment 1.

For a comparative embodiment 2-2, the step 2) of the embodiment 1 is changed to that:

mixing the compound koji material with mussel meat in accordance with the weight ratio of 1:0.5, and adding a mass fraction of 15% of salt; the other steps are same as those in the embodiment 1.

Table 1 below shows the comparison of main characteristics of the embodiment and the comparative embodiments.

TABLE 1

| | Amino acid | | | | |
|---|---|---|---|---|---|
| | nitrogen | | Total acid | | water |
| item | g/100 g | Color and posture | (g/100 g) | flavor | content |
| Embodiment | 0.72 | Yellowish brown, | 1.65 | Mellow, fresh and | 45.7% |
| 1 | | shiny, moderate | | sweet; coordination of | |
| | | viscosity, even texture | | soysauce-like aroms, | |
| | | | | mellow flavor and ester | |
| | | | | flavor | |
| Comparative | 0.64 | Yellowish brown, | 1.61 | Not mellow enough, | 45.0% |
| embodiment | | shiny, moderate | | light sweet taste; | |
| 1-1 | | viscosity, even texture | | soysauce-like aroms, | |
| | | | | ester flavor, light aroma | |
| Comparative | 0.61 | Yellowish brown, | 1.58 | Not mellow enough, | 45.9% |
| embodiment | | shiny, moderate | | light sweet taste; | |
| 1-2 | | viscosity, even texture | | light aroma | |
| Comparative | 0.65 | Yellowish brown, | 1.60 | Not mellow enough, | 46.3% |
| embodiment | | shiny, moderate | | light sweet taste; | |
| 1-3 | | viscosity, even texture | | soysauce-like aroms, | |
| | | | | ester flavor, light aroma | |
| Comparative | 0.62 | Light yellowish brown, | 1.68 | Not mellow enough, | 46.7% |
| embodiment | | shiny, slightly sparse, | | light sweet taste; | |
| 1-4 | | even texture | | soysauce-like aroms, | |
| | | | | ester flavor, light aroma | |
| Comparative | 0.55 | Light yellowish brown, | 1.94 | not obvious salty and | 49.6% |
| embodiment | | shiny, thin, slightly | | sweet taste, fishy, | |
| 1-5 | | layered | | slightly sour, fishy smell | |
| | | | | of seafood and pungent | |
| | | | | vinegar smell | |
| Comparative | 0.66 | Yellowish brown, | 1.64 | heavy fishy smell, the | 49.2% |
| embodiment | | slightly green, shiny, | | salty taste is stronger | |
| 2-1 | | thin, slightly layered | | than the sweet taste, the | |
| | | | | fishy smell and mellow | |
| | | | | smell of seafood | |
| Comparative | 0.56 | Brownish yellow, weak | 1.59 | Fresh and sweet, with | 44.2% |
| embodiment | | gloss, slightly viscous | | bitter and astringent | |
| 2-2 | | | | aftertaste, sauce flavor | |
| | | | | and burnt taste | |

As can be seen from Table 1 above, the method can effectively shorten the production cycle and the prepared mussel bean paste is significantly enhanced in all aspects of nutrition, appearance, and flavor.

Finally, it should also be noted that the above embodiments are only illustrated embodiments of the disclosure. Obviously, the disclosure is not limited to the above embodiments, but can also have many variations. All the variations that can be directly derived or associated by those skilled in the art from what is disclosed in the disclosure shall be considered as the scope of protection of the disclosure.

What is claimed is:

1. A method for preparing mussel bean paste, comprising:
making koji, comprising:
S1, sterilizing soaked soybeans, adding mussel cooking liquor hydrolysate into the soaked soybeans, and then inoculating Aspergillus oryzae with a inoculum amount of 0.1% to obtain a first koji material, placing the first koji material in an incubator with a first temperature of 28° C. to 32° C. and a first relative humidity of (85±2) % for static culture to make koji for 2 days to 4 days to obtain soybean koji; wherein a weight ratio of the mussel cooking liquor hydrolysate to the soaked soybeans is in a range of 4% to 10%;
wherein the mussel cooking liquor hydrolysate is obtained by concentrating mussel cooking liquor and then performing enzymic hydrolysis with flavor protease;
S2, sterilizing soaked rice, inoculating Aspergillus oryzae with an inoculum amount of 0.1% to obtain a second koji material, and placing the second koji material in an incubator with a second temperature of 28° C. to 32° C. and a second relative humidity of (85±2%) for static culture to make koji for 2 days to 4 days to obtain rice koji;
S3, mixing the rice koji with the soybean koji to obtain a koji material; wherein a weight ratio of the rice koji to the soybean koji is 1:0.5 to 2;
fermentation, comprising:
adding the koji material and salt into mussel meat to form a fermentation system, sealing after mixing evenly, and obtaining a mussel bean paste semi-finished product through anaerobic fermentation at 37° C. to 42° C. for 21 days to 30 days;
wherein a weight ratio of the mussel meat to the koji material is 1:0.5 to 2;
wherein a quality of the salt accounts for 10-16% of the fermentation system;
grinding paste and sterilizing, comprising:
grinding the mussel soybean paste semi-finished product by using a colloid mill, and sterilizing to obtain the mussel soybean paste.

2. The method for preparing mussel bean paste according to claim 1,
wherein in the S1, opening an incubator door every 6 hours to ventilate (5±0.5) min, turning the first koji material for a first time when first surface mycelium makes the first koji material caking, and turning the first koji material again when a temperature of the first koji material rises above 35° C.; and
wherein in the S2: opening an incubator door every 6 hours to ventilate (5±0.5) min, turning second koji material for a first time when second surface mycelium makes the second koji material coking, and turning the second koji material again when a temperature of the second koji material rises above 35° C.

3. The method for preparing mussel bean paste according to claim 2,
wherein in the S1, the first temperature is 31° C., and the first relative humidity is 85%; and
wherein in the S2, the second temperature is 31° C., and the second relative humidity is 85%.

4. The method for preparing mussel bean paste according to claim 1, wherein a method for preparing the mussel cooking liquor hydrolysate, comprising:
concentrating the mussel cooking liquor to 15-20% of an original volume of the mussel cooking liquor to obtain a concentrated liquid; and
adding the flavor protease with a weight of 0.3% of a weight of the concentrated liquid into the concentrated liquid, and performing the enzymatic hydrolysis at 35° C. to 50° C. for 1 h to 3 h, and obtaining the mussel cooking liquor hydrolysate after enzyme inactivation.

5. The method for preparing mussel bean paste according to claim 4, wherein the weight ratio of the mussel meat to the koji material is 1:1.

6. A mussel bean paste prepared by the method according to claim 1.
